(19) United States
(12) Patent Application Publication
(10) Pub. No.: US 2007/0240585 A1
(43) Pub. Date: Oct. 18, 2007

(54) Embossing system, methods of use, and articles produced therefrom

(76) Inventors: Nitin Vaish, Evansville, IN (US); Yu Hu, Evansville, IN (US); Kevin Partrick Capaldo, Mount Vernon, IN (US); Chung Hei Yeung, Evansville, IN (US); Nitin Garg, Evansville, IN (US)

Correspondence Address: CANTOR COLBURN, LLP, 55 GRIFFIN ROAD SOUTH, BLOOMFIELD, CT, 06002, US

(21) Appl. No.: 11/403,576

(22) Filed: Apr. 13, 2006

(51) Int. Cl. B44B 5/00; B29C 59/00

(52) U.S. Cl. 101/3.1

(57) ABSTRACT

Disclosed herein is an embossing system, methods for its use, and articles produced therefrom. In one embodiment, the embossing system comprises: an embossing apparatus, a coating zone, and a curing zone. The embossing apparatus is capable of producing an embossed film. The coating zone is capable of disposing a coating onto the surface features, wherein the coating comprises a well depth that is equal to or greater than one-half of the average height of the surface features. In one embodiment, a film making process comprises: heating a polymer, embossing the polymer to form an embossed film, disposing a coating on the embossed film, and curing the coating.

### BACKGROUND OF THE INVENTION

Embossed films have been employed in a wide range of applications. In one application, embossed films have been successfully employed as optical films. Embossed films utilized in optical applications are embossed with prismatic surface features that are capable of diffusing, directing, polarizing, and/or concentrating light. As a result, embossed optical films are generally employed in many illuminated display applications (e.g., televisions, monitors, cellular telephones, personal data assistants, personal gaming devices, traffic signals, advertising displays, lighting and so forth). Embossed films also find utility in other applications, such as disposable hygienic films, such as, diapers, incontinence products, sanitary products, wound care products, and so forth.

Embossed films can be formed using various methods. Generally, the embossed surface features are formed through contact with a master pattern that comprises a negative image of the surface that is desired. In one method, a polymer film can be heated to a temperature that is sufficient to flow the polymer into the pattern, which is referred to as “hot embossing”. To be more specific, during the hot embossing process a polymer film is heated and compressed against an embossing drum or belt that comprises a negative image of the desired pattern. The heated film contours or flows into the surface features of the master pattern. The polymer is subsequently cooled and stripped from the master pattern.

What are needed in the art are simplified, efficient embossing systems, and methods for their use.

### SUMMARY OF THE INVENTION

Disclosed herein is an embossing system, methods of its use, and articles produced therefrom.

In one embodiment, the embossing system comprises: an embossing apparatus, a coating zone, and a curing zone. The embossing apparatus is capable of producing an embossed film. The coating zone is capable of disposing a coating onto the surface features, wherein the coating comprises a well depth that is equal to or greater than one-half of the average height of the surface features.

In another embodiment, an embossing system comprises: an embossing apparatus capable of producing an embossed film, an annealing zone disposed downstream of the embossing apparatus, a coating zone disposed downstream of the annealing zone, and a curing zone disposed downstream of the coating zone and upstream of a take-up roller.

In one embodiment, a film making process comprises: heating a polymer, embossing the polymer to form an embossed film, disposing a coating on the embossed film, and curing the coating.

In another embodiment, a film making process is disclosed. The process comprises, heating a substrate film, embossing the substrate film to form an embossed film, disposing a coating on the embossed film, and curing the coating to form a coated embossed film. The embossed film comprises surface features having an average height. The coating comprises a well depth that is equal to or greater than one-half of the average height of the surface features.

In another embodiment, an embossed film is disclosed. The embossed film comprises, a substrate layer comprising surface features wherein the surface features comprise an average height. The embossed film further comprises a coating disposed on the surface features wherein the coating comprises a well depth that is equal to or greater than one-half of the average height of the surface features.

In one embodiment, an embossed film comprises: a substrate layer comprising surface features and a coating disposed on the surface features. The surface features comprise an average height, and the coating comprises a well depth that is equal to or greater than one-half of the average height of the surface features.

The above described and other features are exemplified by the following figures and detailed description.

### BRIEF DESCRIPTION OF THE DRAWINGS

Refer now to the figures, which are meant to be exemplary and not limiting, and wherein like elements are numbered alike.

FIG. 1 illustrates a side view of an exemplary embossing system.

FIG. 2 illustrates a partial and cross-sectional view of an exemplary embossed film.

FIG. 3 illustrates a partial and cross-sectional view of an exemplary embossed film.

### DETAILED DESCRIPTION OF THE INVENTION

At the outset, unless defined otherwise, technical and scientific terms used herein have the same meaning as is commonly understood by one of skill in the art to which this invention belongs. The terms “a” and “an” do not denote a limitation of quantity, but rather, denote the presence of at least one of the referenced item. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Furthermore, as used herein, “combination” is inclusive of blends, mixtures, alloys, reaction products, and the like.

Disclosed herein are embossing systems, methods for their use, and articles produced therefrom. The embossing systems integrate secondary operations in-line with the production of embossed films. The integration of secondary operations in-line with the production of an embossed film can provide advantages over alternative systems, for example, increasing the value of the final product, and reducing the use of off-line operations that can damage the film due to transfers, handling, and the like. In addition, coated embossed films are disclosed that provide improved light transmission compared to alternative coated films. The coated embossed films provide improved light transmission as the coating approximately replicates the contours of the surface features disposed on the embossed film, therefore allowing the coated embossed film to redirect at least a portion of reflected light into the film.

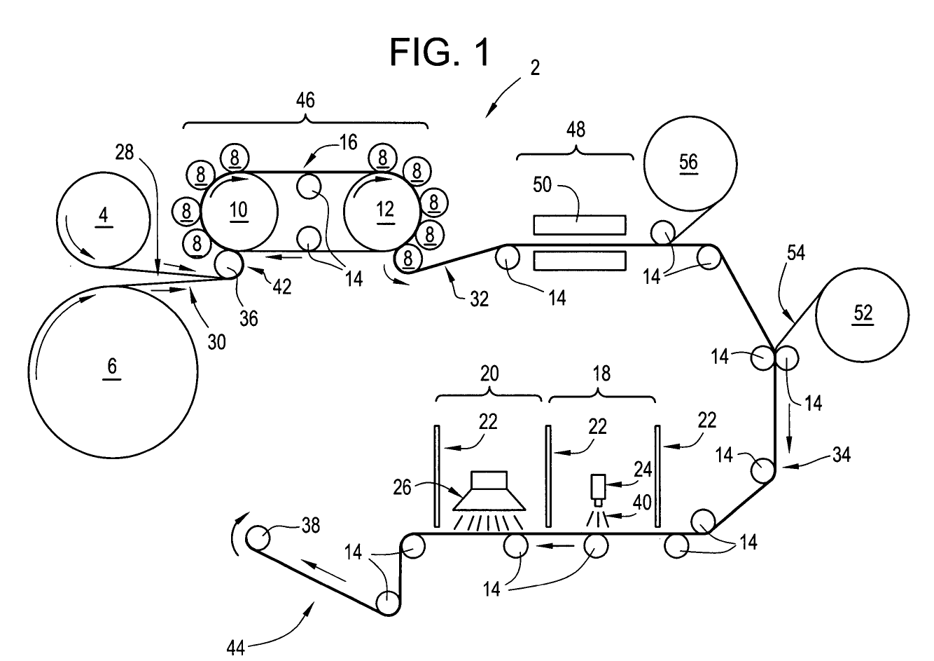

Referring now to FIG. 1, an exemplary embossing system 2 is illustrated. The embossing system 2 comprises an embossing apparatus 46 capable of producing an embossed film 32. The embossing system 2 also comprises secondary operations, namely, an annealing process (e.g., via annealing zone 48), and a coating process (e.g., via coating zone 18 (e.g., an on-line and/or off-line coating zone(s))) wherein the annealing process is capable of annealing the embossed film 32 and the coating process is capable of applying a coating onto the embossed film 32, for example to improve the properties of the embossed film 32 (e.g., scratch resistance, chemical resistance, and/or weatherability). In one configuration, the embossing system 2 has the annealing zone 48 is disposed downstream of the embossing apparatus 46, the coating zone 18 is disposed downstream of the annealing zone 48, and the curing zone 20 disposed downstream of the coating zone 18 and upstream of the take-up roller 38.

The embossing system 2 can be configured to comprise any configuration of secondary processes. Secondary operations include any process performed on and/or to the film subsequent to embossing, e.g., that modifies, adds value to, and/or changes the properties of an embossed film 32, as well as combinations comprising at least one of the foregoing. For example, secondary operations comprise, coating operations, annealing processes, printing, trimming, further assembly, laminating, forming, as well as combinations comprising at least one of the foregoing.

The embossing apparatus 46 comprises an embossing belt 16 that travels about a heating roller 10 and a chill roll 12, as shown by the directional arrows. The embossing belt 16 is supported between the heating roller 10 and the chill roll 12 by two support rollers 14. A support film roll 4 supplies a support film 28, and a substrate film roll 6 supplies a substrate film 30 to a lead compression roller 36, where the support film 28 and the substrate film 30 (hereinafter referred to as “films”) can be layered to form a laminate 42. In an alternative embodiment, the embossing apparatus 46 can comprise an extruder that feeds a molten polymer to a nip between calandaring rolls (not shown).

The substrate film 30 comprises polymers that demonstrate desirable optical properties. For example, transparent polymers exhibiting a transmission (Tr) of greater than about 80%, or more specifically greater than about 90%, (as measured by ASTM D1746-03) are desirable. One such polymer exhibiting these properties is polycarbonate (e.g., Lexan, manufactured by General Electric Company, GE Plastics, Pittsfield, Mass.). The thickness of the substrate layer 30 can comprise a thickness of about 2 mil (51 micrometers (μm)) to about 60 mil (1,524 μm), however it is apparent that the specific thickness is a function of the materials employed, the embossing process, end-users requirements, and other variables.

The optional support film 28 can support the substrate film 30 as it is heated. In addition, the support film 28 can protect the surface finish of the substrate film 30 during embossing and prevent the substrate film 30 from adhering to the compression rollers 8. The support film 28 can comprise polymeric materials that comprise a glass transition temperature (Tg) and/or melt temperature (Tm) that is higher than the substrate film 30, so that the support film 28 can support the substrate film 30 as it is preheated and prevent the substrate film 30 from deforming. One such polymer that has exhibited success in this application is polyethylene terephthalate (e.g., Mylar, manufactured by E.I. du Pont de Nemours and Company, Wilmington, Del.). A polyethylene terephthalate does not adhere to many substrate films 30, which allows for easy removal therefrom. Support film 28 can comprise a sufficient thickness to attain the desired structural properties, e.g., it can have a thickness of about 2 mil (51 μm) to about 60 mil (1,524 μm), however it is apparent that the specific thickness is a function of the materials employed, the embossing process, end-users requirements, as well as other variables.

The laminate 42 (e.g., the term “laminate” is used to denote a layered structure and does not imply a bond therebetween) travels around a lead compression roller 36 to contact the embossing belt 16. Upon contact with the embossing belt 16, the laminate 42 and the embossing belt 16 are compressed between the lead compression roller 36 and the heating roller 10 (e.g., this can be referred to as a “nip” or a “nip section”). As the laminate 42 and the embossing belt 16 travel through an annular array of nip sections via compression rollers 8, the heating roller 10 heats the embossing belt 16 and the laminate 42. The laminate 42 is heated to a temperature that is sufficient to allow the substrate film 30 to flow into surface features that are disposed on the surface of the embossing belt 16 (not shown), forming an embossed film 32.

The embossed film 32 then travels on the embossing belt 16 under a series of compression rollers 8 disposed in an annular array about the chill roll 12, which cools the embossed film 32 so that the geometry of the surface features in the embossing belt 16 are retained on a surface of the embossed film 32. The embossed film 32 is then stripped from the embossing belt 16.

The embossing belt 16 can comprise an endless belt formed from a metal (e.g., nickel), metal alloy (e.g., martensitic, ferritic, and austenitic stainless materials, and/or nickel-titanium alloy), polymer (e.g., EPDM, silicone, and so forth), as well as combinations comprising at least one of the foregoing. For example a nickel embossing belt 16 comprising a thickness of about 0.010 inches (254 μm) to about 0.200 inches (5,080 μm) can be employed. Furthermore, the embossing belt 16 can be configured to comprise any configuration of surface features that produce a desirable embossed film 32. The surface features can be formed in the embossing belt 16 utilizing various method, such as, etching, electrical discharge machining, stamping, milling, and so forth.

The rollers (i.e., lead compression roller 36, heating roller 10, compression rollers 8, support rollers 14, take-up roller 38, masking film roll 52, support film take-up roll 56, and chill roll 12) can be disposed in a relationship that is about parallel with one another, which promotes uniform thickness and uniform residual stresses across the width of the embossed film 32. Furthermore, the rollers can be configured in any configuration that provides ample heating, cooling, compression, and support for the embossed film 32. The rollers can be manufactured from metals (e.g., copper, aluminum, and/or iron), metal alloys (e.g., martensitic, ferritic, and/or austenitic stainless materials), polymers (e.g., ethylene propylene diamine monomer based rubber (EPDM) or silicone), as well as configurations comprising at least one of the following. For example, in one embodiment, a roller can comprise 316 stainless steel and a chromed external surface coating. The outer surface of the rollers generally comprises a smooth, polished surface, however, can comprise a texture, pattern, and the like. The rollers can also comprise thermal elements, flow paths and/or conduits, and so forth, to enable control of the roller's temperature. For example, the rollers 10, 12, can be configured to comprise an internal geometry comprising a flow path (e.g., spiral) through which a thermal transfer media (e.g., oil, ethylene glycol, and/or water) can flow. The flow path can comprise an inlet disposed on one end of the roller's axel and an outlet disposed on the other end of the roller's axel. In another example, the heating roller 10 can comprise a spirally wrapped resistive heating element capable of connecting to an electrical source and heating the roller.

During operation, the compression rollers 8 can exert a force of about 10 to about 100 pounds per square inch, (psi) (about 0.703 to about 7.031 kilograms per square centimeter, K/cm²) on the film, or more specifically about 25 to about 90 psi (about 1.76 to about 6.33 K/cm²), or even more specifically about 50 to about 80 psi (about 3.52 to about 5.62 K/cm²). The laminating roller can exert about 0.1 to about 10 psi (about 0.007 to about 0.070 K/cm²) on the film, or more specifically about 0.5 to about 5 psi (about 0.035 to about 0.352 K/cm²), or even more specifically about 1 to about 2.5 psi (about 0.070 to about 0.176 K/cm²).

The embossed film 32 can be embossed with surface features comprising any shape that can be embossed into the film. Possible surface features include light-reflecting elements such as cube-corners (e.g., triangular pyramid), trihedral, hemispheres, prisms, ellipses, tetragonal, grooves, channels, microlenses, and others, as well as combinations comprising at least one of the foregoing. The specific configuration of the surface features (e.g., height, shape, and/or width) will influence the characteristics of the embossed film. For example, in optical films, influencable characteristics include, light incidence angles, prismatic effect of the feature, reflections of light within the feature, total light transmission, and so forth, as well as combinations comprising at least one of the foregoing.

The embossing apparatus 46 is capable of producing embossed films 32 comprising macroscale, microscale and/or nanoscale surface features. Macroscale surface features have a size of approximately 1 millimeter (mm) to about 1 meter (m) or the entire size of the part being formed; i.e. of a size scale easily discerned by the human eye. Microscale surface features have a size of less than or equal to about 1 mm, or, more specifically, greater than 100 nanometers (nm) to about 1 mm. Nanoscale surface features have a size of less than or equal to about 500 nm, or, more specifically, less than or equal to about 100 nm, or, even more specifically, less than or equal to about 20 nm, and yet more specifically, about 0.5 nm to 10 nm.

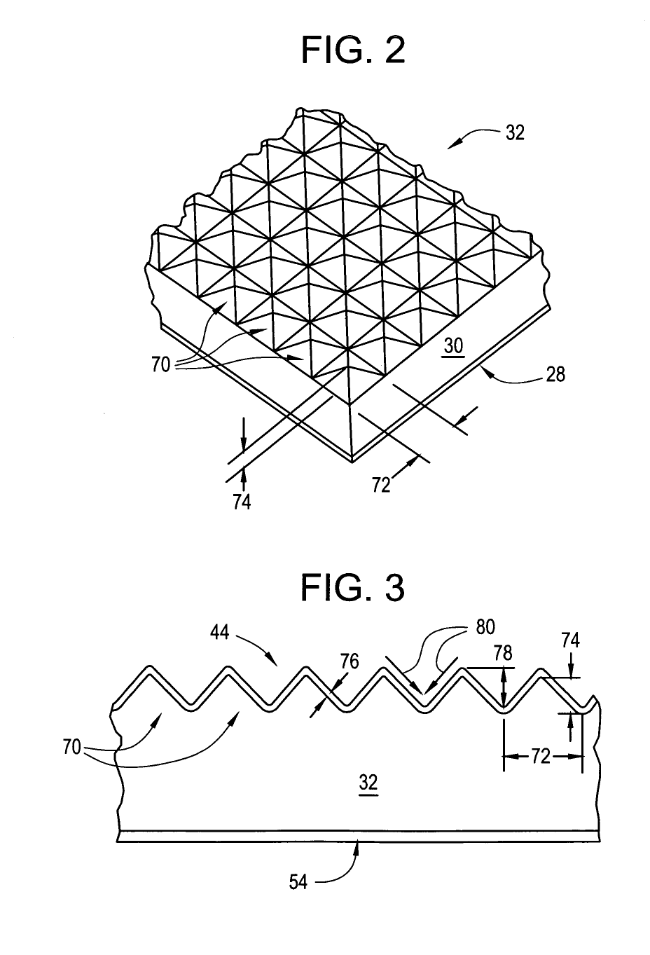

Referring also to FIG. 2, the embossed film 32 comprises a substrate film 30 comprising micro-scale surface features 70 that have been formed thereon by embossing apparatus 46. The support film 28 is disposed on the substrate film 30 opposite the micro-scale surface features. The micro-scale surface features 70 comprise pyramidal geometries, having a base width 72 and a height 74. For example, the base width 72 is about 30 micrometers, μm (about 0.0011 in) and the height 74 is about 20 μm (about 0.0008 in).

Once the embossing apparatus 46 has formed the embossed film 32, it is conveyed on support rollers 14 through the annealing zone 48. The annealing zone 48 can comprise one or more annealing system 50. The annealing system 50 is designed to reduce residual stresses within the embossed film 32 utilizing thermal energy via irradiative, convective, and/or conductive methods. For irradiative and convective methods, the annealing system 50 can be configured similar to an oven, wherein irradiative or convective heat can be transmitted to the embossed film 32 without direct contact. For example, quartz infrared irradiative heaters can be employed to heat the embossed film. For conductive methods, the annealing zone 48 can comprise one or more heated calendaring rolls (not shown), which the film is disposed in contact with. For example, the calendaring rolls can be comprise stainless steel having a mirror-quality finish and configured with internal conduits to allow for a heated media, such as oil, to be circulated therethrough. Regardless of the method of thermal transfer, the annealing system 50 can be configured at any width or length required to anneal the embossed film 32. In addition, the annealing system 50 can be disposed at any position after the embossed film 32 has been formed, such as after the coating zone 18.

During the annealing process, the embossed film 32 is heated to a temperature that is sufficient to attain the desired residual stress level within the film. However, to avoid deformation of the film and/or surface features, the temperature employed is less than the glass transition temperature of the film For example, embossed films comprising greater than or equal to about 93 wt. % polycarbonate (e.g., having a Tg of about 320° F.) can be heated to a temperature of about 270° F. (about 132° C.), wherein the weight percent is based on the total weight of the film.

After the embossed film has been annealed in the annealing zone 48, the support film 28 is removed from the embossed film 32 and spooled on a support film take-up roll 56. Thereafter, a masking film 54 supplied by the masking film roll 52, is laminated onto a surface of the embossed film 32 opposite the embossed surface.

The masking film 54 can protect the surface finish of the embossed film 32 during secondary manufacturing operations. It is desirable for the masking film 54 to comprise a polymer that can be easily removed from the embossed film 32 and is cost effective for the manufacturer. For example, one such polymer that has exhibited success is high-density polyethylene (e.g., Marlex, manufactured by Chevron Phillips Chemical Company LLP, Woodlands, Tex.). The masking film 54 can comprise a thickness of about 2.0 mils to about 20.0 mils (about 50.8 to about 508 μm), however it is apparent that the specific thickness depends upon of the materials employed, the embossing process, end-users requirements, and other variables.

Once the masking film 54 has been disposed on the embossed film, the resulting masked embossed film 34 travels along support rollers 14 to a coating zone 18. The coating zone 18 is capable of applying a coating 40 onto the masked embossed film 34 to form a coated embossed film 44.

Referring now to FIG. 3, an exemplary coated embossed film 44 is illustrated. The coated embossed film 44 comprises an embossed film 32 comprising micro-scale surface features 70 having a base width 72 and a height 74. Disposed on the micro-scale surface features 70 is a coating 40, which comprises a thickness 76 and a well depth 78. Disposed on the embossed film 32 on the side opposite the micro-scale surface features 70 is a masking film 54.

The coating 40 approximately replicates the contours of the micro-scale surface features 70. However, based on the coating's properties (e.g., viscosity, wetting capability and so forth), as well as processing variable (e.g., time elapse before coating is cured, coating application method, and so forth), after the coating 40 is applied, it can flow down the micro-scale surface features 70 (as illustrated by flow arrows 80) and accumulate between surface features prior to curing. Advantageously however, the resulting well depth 78 of the coating 40 is equal to or greater than one-half (e.g., 50%) of the average height 74 of the micro-scale surface features 70, or more specifically, greater than or equal to about 75%, or even more specifically, greater than or equal to about 90%, such that the coating approximately replicates the surface features. For example, in one embodiment, the micro-scale surface features 70 comprise a height 74 of about 500 μm (19.7 thousandths of an inch, mils). A coating 40 disposed on the micro-scale surface features 70 comprises a well depth 78 of about 400 μm (15.7 mils). The coating 40 can comprise a thickness 76 that is equal to or less than about 500 micrometers, μm (19.7 thousandths of an inch, mils), or more specifically, equal to or less than about 300 μm (11.8 mils), or even more specifically, equal to or less than about 100 μm (3.94 mils).

The embossed film 32 provides improved light transmission compared to flat films. Although not limited by theory, this is achieved via the prismatic effects of the surface features, which are capable of redirecting at least a portion of the light reflected off of the surface features back into the film. Alternatively, light reflected off of a flat film is not directed back into the film. Advantageously, the coated embossed film 44 comprises a coating 40 that approximately replicates the contours of the surface features (e.g., micro-scale surface features 70), which also enables at least a portion of reflected light to be directed into the film and provides improved light transmission. However, if an embossed films comprises a coating having a well depth 78 that is less than one-half (e.g., equal to or less than 49.9%) of the average height 74 of the micro-scale surface features 70, the surface features are inadequately replicated by the coating, and the film is inefficient at redirecting reflected light to sufficiently increase total.

Referring again to FIG. 1, the coating zone 18 can be configured in any manner to coat an embossed film 32 while following the contours of the embossed film. In the embodiment illustrated, the coating zone 18 comprises nozzles 24 that are configured to distribute (e.g., spray) a layer of the coating 40 onto the embossed side of masked embossed film 34. The nozzles 24 can comprise any design that is capable of distributing the coating 40 onto the film, such as, high pressure nozzles that can distribute droplets of coating onto the masked embossed film 34 wherein the droplets have a diameter of less than or equal to about 500 μm (about 19.7 mils), or more specifically, less than or equal to about 300 μm (about 11.8 mils) or even more specifically, less than or equal to about 100 μm (about 3.94 mils) in diameter.

In addition, the nozzle 24 can be configured in any configuration and/or orientation. For example, in one embodiment a masked embossed film 34 comprising a width of about 50 centimeters (cm) (about 19.69 in) can be coated with ten nozzles oriented in an evenly spaced (i.e., disposed 5 cm (1.97 in) apart) linear array across the film's width wherein the nozzles 24 are configured with a “fan-type” spray pattern. The specific spray pattern and distance from the film to the nozzle 24 can be adjustable to minimize spray overlap of adjacent spray patterns as well as increase coating uniformity. In another embodiment, the masked embossed film 34 can be oriented so that the micro-scale surface features 70 are disposed on the bottom of the masked embossed film 34 and the nozzles 24 are directed in an upward direction to coat the film, which can minimize accumulation of the coating 40 within the “well” between the surface features.

Depending on embossing system 2 throughput, the number of nozzles 24 employed, and the desired coating 40 thickness 76, volumetric flow rate through the nozzles 24, and nozzle 24 pressure can be adjustable to attain the desired results. For example, in the embodiment discussed above, each nozzle 24 can be operated at a pressure of about 1,000 to about 2,500 psi (about 70.3 kilometers per square centimeter (K/cm²) to about 175.8 K/cm²) and provide a volumetric flow rate of about 0.1 gallon per hour (gal/hr) to about 10.0 gal/hr (about 0.006 liter per minute (L/min) to about 0.631 L/min) at a line speed of about 10 feet per minute (ft/min) (3.048 meters per minute (m/min)).

Additional methods of applying the coating 40 to the masked embossed film 34 can be employed. For example, a wiper blade can be employed to spread a coating 40, a flexible foam-dispensing roller can be employed, and so forth, as well as combinations comprising at least one of the foregoing methods.

After the coating 40 has been applied to the masked embossed film 34, the coated embossed film 44 travels through a curing zone 20.

The curing zone 20 can comprise any energy source 26 (e.g., thermal, irradiative, and so forth, as well as combinations comprising at least one of the foregoing) that is capable of curing the coating 40. In one embodiment, energy source 26 can comprise a light capable of curing the coating 40. Any light can be employed that is capable of producing radiation at a wavelength that initiates a curing reaction of the coating 40. The light can comprise radiation such as UVA, UVB, UVC, UVV, and so forth. Exemplary configurations include ultraviolet (UV) lamps comprising xenon, metallic halide lamps, metallic arc lamps, low-pressure mercury vapor discharge lamps, high-pressure mercury vapor discharge lamps, and so forth, as well as combinations comprising at least one of the foregoing. An exposure dose of equal to or greater than about 0.100 joules per square centimeter (J/cm²) can be adequate to cure a UV curable coating 40, however equal to or greater than about 0.300 J/cm², or even equal to or greater than about 0.500 J/cm² can be employed. In another embodiment, the energy source 26 can comprise a heat source that is capable of activating a thermally activated initiator within the coating. If employed, the heat source could also provide an annealing function. The curing zone 20 can be configured to comprise a length and any number of energy sources 26 that are sufficient to cure the coating 40.

Partitions 22 can be employed to enclose the coating zone 18 and the curing zone 20 for the purpose of ensuring energy source 26 does not initiate the curing reaction prematurely. In addition, partitions 22 can be employed to enclose each of the zones (e.g., coating zone 18 and/or curing zone 20) to allow for environmental control of each zone separately or combined. For example, the coating zone 18 and curing zone 20 can comprise an environment favorable for applying and curing a coating 40, such as an environment having an elevated temperature comprising a low dew-point (less than about 10%, or even less than about 5%). Furthermore, an environmental control system can be employed comprising a filtration system capable of removing foreign matter to avoid foreign particulate deposition in the coating.

During production, the line-speed of the embossing system 2 can be any speed that can produce an embossed film 32 having sufficient surface feature replication. For example, a line-speed equal to or greater than about 2 ft/min(about 0.6 m/min), or more specifically, equal to or greater than about 20 ft/min (about 6 m/min), or even more specifically, equal to or greater than about 40 ft/min (about 12 m/min) can be employed.

After the coating 40 has been cured, the coated embossed film 44 is spooled onto a take-up roll 38. The protective masking film 58 (e.g., a pressure sensitive masking film) can be applied on the embossed side of the film 44 before the product roll is wound on the take-up roll 38. The protective masking film 58 can have a sufficient thickness to protect the embossed features from damage, e.g., can have a thickness of about 1 mil (25 micrometers (μm)) to about 3 mils (76 μm).

In one embodiment, an embossed film 32 can be produced from a substrate comprising polycarbonate via an embossing apparatus 46. After the embossed film 32 has been formed it can be routed through a coating process (e.g., comprising a coating zone 18 and a curing zone 20), wherein a coating 40 is applied, e.g., sprayed onto the embossed side of the film such that the film follows the contours of the embossing. The coating zone and/or the curing zone can be on-line (i.e., part of the embossing system such that the film passes through the coating process prior to being wound on the take-up roll 38 and transferred for further processing and/or use), or off-line (i.e., not part of the embossing line such that the film is removed from the embossing line enter the coating process). It is further noted that the coating zone, annealing zone, and/or curing zone, can be disposed in a different arrangement, e.g., the coating (which is optional) can be disposed onto the embossed surface prior to annealing.

In another embodiment, the coating 40 can comprise a thermally activated initiator wherein the energy source 26 is capable of curing the coating 40. The heat source can be capable of heating the coating 40 utilizing any of irradiative, conductive, and/or convective methods. For example, energy source 26 can comprise an irradiative quartz heater capable of heating the coating 40 above the initiation temperature of the thermal initiator.

In yet another embodiment, a multi-component coating 40 can be employed. The multi-component coating 40 can comprise an initiator component that is mixed with a resin component, enabling the multi-component coating 40 to cure thereafter as the result of a reaction comprising these components. The initiator component and the resin component can be mixed prior to application onto the masked embossed film 34, or can be applied separately.

In yet another embodiment, more than one coating 40 can be applied to the masked embossed film 44. For example, a first coating 40 can be applied on an embossed film 32 and cured wherein the first coating 40 provides improved chemical resistance. A second coating 40 can then be applied to the first coating 40 and cured thereon wherein the second coating 40 provides improved scratch resistance.

In yet another embodiment, coatings can be applied to the non-embossed side of the embossed film 32, or to both sides of the embossed film 32.

The embossed film 32 can be produced to comprise additional layers. For example, a second layer can be disposed between the support film 28 and the substrate film 30 to provide improved properties (e.g., strength, clarity, weatherability and the like).

Disclosed herein are embossing systems, methods for their use, and articles produced therefrom. The embossing systems integrate secondary operations in-line with the production of embossed films. The integration of these secondary operations in-line with the production of an embossed film provide advantages over alternative systems, for example, increasing the value of the final product, and reducing the use of off-line operations that can damage the film due to transfers, handling, and the like. In addition, coated embossed films are disclosed that provide improved light transmission compared to alternative coated films. The coated embossed films provide improved light transmission as the coating approximately replicates the contours of the surface features disposed on the embossed film, therefore allowing the coated embossed film to redirect at least a portion of reflected light into the film.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An embossing system, comprising:
an embossing apparatus capable of producing an embossed film, wherein the embossed film comprises surface features having an average height;
a coating zone capable of disposing a coating onto the surface features; and
a curing zone capable of curing the coating;
wherein the coating comprises a well depth that is equal to or greater than one-half of the average height of the surface features.

2. The system of claim 1, wherein the coating comprises a polymer that is UV irradiation curable and/or thermally curable.

3. The system of claim 1, wherein the surface features are micro-scale surface features.

4. The system of claim 1, further comprising a secondary operation, wherein the secondary operation includes any process performed on and/or to the film subsequent to embossing.

5. The system of claim 1, wherein the well depth is greater than or equal to about 75% of the average height of the surface features.

6. The system of claim 5, wherein the well depth is greater than or equal to about 90% of the average height of the surface features.

7. A film making process, comprising:
heating a polymer;
embossing the polymer to form an embossed film, wherein the embossed film comprises surface features having an average height;
disposing a coating on the embossed film; and
curing the coating to form a coated embossed film;
wherein the coating comprises a well depth that is equal to or greater than one-half of the average height of the surface features.

8. The process of claim 7, wherein the surface features are micro-scale surface features.

9. The process of claim 7, wherein the well depth is greater than or equal to about 75% of the average height of the surface features.

10. The process of claim 9, wherein the well depth is greater than or equal to about 90% of the average height of the surface features.

11. The process of claim 7, further comprising annealing the embossed film.

12. The process of claim 7, wherein curing the coating further comprises irradiating the coating with UV radiation.

13. An embossed film, comprising:
a substrate layer comprising surface features, wherein the surface features comprise an average height; and,
a coating disposed on the surface features, wherein the coating comprises a well depth that is equal to or greater than one-half of the average height of the surface features.

14. The process of claim 13, wherein the surface features are micro-scale surface features, and wherein the well depth is greater than or equal to about 75% of the average height of the surface features.

15. An embossing system, comprising:
an embossing apparatus capable of producing an embossed film;
an annealing zone disposed downstream of the embossing apparatus;
a coating zone disposed downstream of the annealing zone; and
a curing zone disposed downstream of the coating zone and upstream of a take-up roller.

16. The system of claim 15, wherein the embossing apparatus is capable of producing the embossed film with surface features having an average height, and wherein the coating comprises a well depth that is equal to or greater than one-half of the average height of the surface features.
